(19) United States
(12) Patent Application Publication
(10) Pub. No.: US 2024/0031659 A1
(43) Pub. Date: Jan. 25, 2024

(54) AUTOMATED COMMUNICATION PLATFORM FOR LIVE EVENTS

(71) Applicant: VERSUS INC., Toronto (CA)

(72) Inventors: Daryl HEMINGWAY, Toronto (CA); Kaio SANTOS, Toronto (CA)

(21) Appl. No.: 18/245,807

(22) PCT Filed: Sep. 20, 2021
(86) PCT No.: PCT/IB2021/058556

§ 371 Date: Mar. 17, 2023

Related U.S. Application Data
(60) Provisional application No. 63/080,309, filed on Sep. 18, 2020.

(51) Int. Cl. H04N 21/8545; H04N 21/2187; H04N 21/234; H04N 21/235; H04N 21/4788; H04L 51/04

(52) U.S. Cl. CPC H04N 21/8545; H04N 21/2187; H04N 21/23418; H04N 21/2353; H04N 21/4788; H04L 51/04

(57) ABSTRACT

A method in an integration server includes: obtaining broadcast multimedia data representing a live event; receiving, from a client device, recorded multimedia data collected via a sensor of the client device; based on a comparison of the broadcast multimedia data and the recorded multimedia data, determining that the recorded multimedia data represents the broadcast multimedia data being rendered in physical proximity to the client device; in response to the determination, selecting one of a plurality of interaction definitions corresponding to the live event; and controlling a message generator to transmit a message to the client device according to the interaction definition.

### CROSS-REFERENCE TO RELATED APPLICATIONS

This application claims priority to U.S. Provisional Application No. 63/080,309, filed Sep. 18, 2020, the contents of which is incorporated herein by reference.

### FIELD

The specification relates generally to real-time communication, and specifically to an automated communication platform for real-time communications associated with live event broadcasts.

### BACKGROUND

Various communication mechanisms enable users of electronic devices (e.g. smartphones and the like) to exchange messages with one another. Such exchanges may, in some cases, be initiated in response to an event (e.g. a sporting event, or the like). Entities such as businesses or other organizations may wish to automate the initiation of such exchanges with one or more users during an event. Technologies such as chatbots may enable such automation. However, chatbots operate in an asynchronous fashion, disconnected from the physical world and therefore from the real-time occurrence of the events mentioned above and the presence or absence of user attention to such events. The initiation of message exchanges may therefore fall to the users themselves.

### SUMMARY

An aspect of the specification provides a method in an integration server, the method comprising: obtaining broadcast multimedia data representing a live event; receiving, from a client device, recorded multimedia data collected via a sensor of the client device; based on a comparison of the broadcast multimedia data and the recorded multimedia data, determining that the recorded multimedia data represents the broadcast multimedia data being rendered in physical proximity to the client device; in response to the determination, selecting one of a plurality of interaction definitions corresponding to the live event; and controlling a message generator to transmit a message to the client device according to the interaction definition.

Another aspect of the specification provides an integration server, comprising: a communications interface; a processor configured to: obtain broadcast multimedia data representing a live event; receive, from a client device, recorded multimedia data collected via a sensor of the client device; based on a comparison of the broadcast multimedia data and the recorded multimedia data, determine that the recorded multimedia data represents the broadcast multimedia data being rendered in physical proximity to the client device; in response to the determination, select one of a plurality of interaction definitions corresponding to the live event; and control a message generator to transmit a message to the client device according to the interaction definition.

A further aspect of the specification provides a non-transitory computer-readable medium storing instructions executable by a processor of an integration server to: obtain broadcast multimedia data representing a live event; receive, from a client device, recorded multimedia data collected via a sensor of the client device; based on a comparison of the broadcast multimedia data and the recorded multimedia data, determine that the recorded multimedia data represents the broadcast multimedia data being rendered in physical proximity to the client device; in response to the determination, select one of a plurality of interaction definitions corresponding to the live event; and control a message generator to transmit a message to the client device according to the interaction definition.

### BRIEF DESCRIPTIONS OF THE DRAWINGS

Embodiments are described with reference to the following figures.

FIG. 1 is a diagram illustrating a system for real-time, interactive communication associated with live events.

FIG. 2 is a diagram illustrating example components of an interactive communication management application of the system of FIG. 1.

FIG. 3 is a flowchart of a method for initiating real-time event-associated interactive communications.

FIG. 4 is a diagram illustrating an example interactive communication definition.

### DETAILED DESCRIPTION

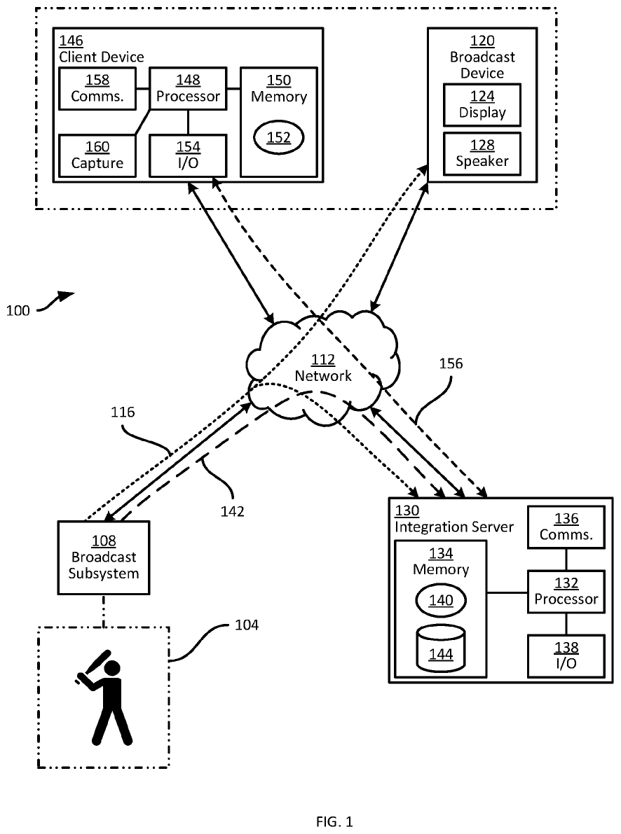

FIG. 1 depicts a system 100 for real-time, interactive communication associated with live events. Live events, such as sporting events (e.g. games), awards shows (e.g. movie, television, and/or music awards), and the like, may be broadcast via television networks, streaming services, and so on. For example, FIG. 1 illustrates a live event 104 such as a baseball game, although it is contemplated that the system 100 can enable the delivery of interactive communications associated with a wide variety of other events, in addition to or instead of the event 104.

The event 104 (and any of a variety of other live events) can be broadcast to a plurality of viewers, e.g. by a broadcast subsystem 108. The broadcast subsystem 108 can include one or more data capture devices, such as cameras, microphones, and the like, to capture multimedia data such as one or more video streams representing the event 104. The above streams can be delivered, e.g. via a network 112 (including any suitable combination of local and wide-area networks), as broadcast data 116. The broadcast data 116 can be delivered to a broadcast device 120, such as a television or other electronic device, for rendering via a display 124 and speaker 128. Rendering of the broadcast data 116 by the broadcast device 120 enables observation of the live event 104 by one or more users.

The broadcasting of events such as the event 104 can be accompanied by the delivery of advertisements or other messages placed by entities such as businesses. While some advertisements are passive, e.g. in the form of previously generated video clips or the like, it may be desirable for some of the above entities to deliver interactive content accompanying the broadcast data 116, e.g. to improve engagement with users watching or otherwise consuming the broadcast of the event.

Delivering such interactive content is subject to certain technical challenges, however. For example, a given live event may be broadcast to different users via different distribution technologies, such as one or more television networks, one or more streaming service providers, and the like. The entity seeking to deliver such interactive content typically has little or no control over which distribution technologies are available, or which distribution technology a given user employs. While the events are referred to as “live” and are generally broadcast substantially in real-time, each distribution technology may apply a different degree of delay to the broadcast. The broadcasts are nevertheless referred to as real-time because the delay represents only a small fraction of the duration of the event (e.g. less than 5% of the duration of the event).

For example, a particular television network may apply a fifteen-second delay, while a particular streaming service may apply a twenty-second delay. The delays applied to different broadcasts vary by distribution technology, and interactive communications associated with the live events represented by the broadcasts may be rendered less relevant, or not relevant, if inappropriately timed.

In addition, the type and content of interactive communications suitable for delivery to users may vary depending on the nature of each live event, and potentially on the users themselves. The breadth of live events represented via broadcasts is such that deploying relevant interactive communications presents technical challenges for entities such as business and advertisers, who generally do not exert control over the broadcasts.

The system 100 therefore includes certain additional components enabling entities to initiate interactive communications with users associated with the broadcast data 116, while mitigating at least some of the above technical challenges. In particular, the system 100 includes an integration server 130 interconnected with the network 112. The integration server 130 implements certain functionality to determine which of a variety of available broadcasts is currently being observed by a given user. The functionality implemented by the server 130 also enables the creation of interactive communication definitions (which may also be referred to as templates), and the delivery of interactive communications according to those definitions. The integration server 130 further enables the selection of which interactive communications are to be delivered to a given user, based on the detection of specific moments in the live event 104, as will be discussed below in greater detail.

In other words, the integration server 130 provides a platform on which a variety of entities can deploy interactive communications for delivery in association with live event broadcasts. The server 130 is illustrated as one computing device in FIG. 1 for simplicity, but can be deployed as a distributed computing system, via a cloud computing platform or the like.

The server 130 includes a processor 132, such as a central processing unit (CPU), connected with a memory 134 (e.g. a suitable combination of volatile and non-volatile memory). As will be apparent, the processor 132 and the memory 134 are implemented as one or more integrated circuits (ICs). The server 130 also includes a communications interface 136 enabling the server 130 to communicate with other computing devices via the network 112. The communications interface 136 therefore includes any suitable hardware and associated firmware and/or software (e.g. a network interface controller or the like) enabling such communication.

The server 130 can also include an input/output assembly 138, e.g. a mouse and/or keyboard, a display, or the like, for use by an operator of the server 130. In other examples, the I/O assembly 138 can be located remotely from the server 130, and connect to the server 130 via the network 112 (e.g. and another computing device, such as a remote management terminal).

The memory 134 stores computer-readable instructions executable by the processor 132 to perform the above-mentioned functionality, e.g. in the form of an interactive communication management application 140, also referred to simply as the application 140. The application 140, when executed by the processor 132, configures the processor 132 to perform various actions discussed herein. In general, the processor 132 is configured via execution of the application 140 to receive the broadcast data 116, as well as metadata 142, from the broadcast subsystem 108. In other examples, the metadata 142 may be received from one or more data sources separate from the subsystem 108, and/or may be generated locally at the server 130.

The metadata defines moments, i.e. specific happenings during the live event 104 that are expected to have particular significance to observers of the event. As a result, the occurrence of a moment is a candidate time for the generation of an interactive communication to be provided to a user. A wide variety of examples moments are contemplated, depending on the nature of the live event. For example, a live event in the form of a soccer game can include moments such as goals, penalty kick calls, corner kicks, red cards, and the like. A live event in the form of an awards show can include the announcement of a winning candidate for a particular category of award. As will now be apparent, a wide variety of moments occur during a given live event 104. Various third-party services identify and codify such moments, particularly in the case of sporting events. The metadata 142 can therefore be received at the server 130 from such third-party services, which can be distinct from the broadcast subsystem 108 or integrated with the broadcast subsystem 108.

The metadata 142 and the broadcast data 116 can be stored in a repository 144 at the server 130. The repository 144 can also contain, as will be described in greater detail below, a set of interactive communication definitions as mentioned above. The definitions are used to generate and send interactive communications to a user. In particular, the server 130 is configured to generate and send, according to a selected definition, an interactive communication to a client computing device 146 operated by a user.

As noted earlier, a number of distinct live events, each resulting in distinct broadcast streams, may occur simultaneously. In order to select an interactive communication definition that is relevant to a given user, the server 130 is further configured to detect that a user is currently observing a broadcast, and to determine which broadcast the user is observing. The server 130 enables at least partial automation of the above detection and determination process via communication with the client device 146 prior to generation of interactive communications. The detection also enables the server 130 to determine the time delay, if any, between the live event 104 and the broadcast data 116.

The identification of a particular live event being observed by the user operating the client device 146 enables the server 130 to identify the appropriate stream of metadata 142 upon which to base the selection of interactive communications to be sent to the client device 146. As will be discussed in greater detail below, the interactive communication definitions correspond to particular moment types. For instance, the repository 144 can include a first definition corresponding to a penalty kick call in a soccer game, and a second definition corresponding to a red card in a soccer game. As will be apparent, a wide variety of interactive communication definitions, for distinct moment types within different event types, can therefore be stored at the server 130. The server 130 is configured to select a particular moment from the metadata 142 for which to generate an interactive communication. Having selected the moment, the server 130 is configured to select a definition corresponding to the same moment type. Various other criteria can also be applied to the selection of moments from the metadata 142, and the subsequent selection of interactive communication definitions.

The client device 146 can include any suitable one of a smart phone, a tablet computer, a desktop computer, a smart television, or the like. The client device 146 thus includes a processor 148 and a memory 150 storing an application 152 executable by the processor 148 to perform various functions enabling the device 146 to communicate with the server 130 to receive and respond to interactive communications. The application 152 can be a dedicated application configured to communicate with the server 130, such as a chatbot application or the like. In other examples, the application 152 can be a web browser, which may be configured to interact with the server 130 by retrieving a particular website or web-based application hosted by the server 130.

The interactive communications can be presented to the user operating the device 146 via an input/output assembly, such as a display, touch screen, keypad, or the like. As will now be apparent, response data to the interactive communications can also be received at the I/O assembly 154 for communication to the server 130 via a link 156 established over the network 112.

The device 146 also includes a communications interface 158 enabling the device 146 to communicate with other computing devices, including the server 130 as noted above. The device 146 further includes a data capture assembly 160, such as a microphone, image sensor, or the like. The data capture assembly 160 is controlled by the processor 148 to record multimedia data rendered by the broadcast device 120, which is co-located with the client device 146. That is, the client device 146 and the broadcast device 120 are in physical proximity to one another (indicated by the dashed box surrounding the client device 146 and the broadcast device 120), e.g. because the user carries the client device 146 on their person, and is observing the broadcast data 116 via the broadcast device 120. The recorded data can then be provided to the server 130 to enable the server 130 to determine which live event 104 the user is observing via the broadcast device 120.

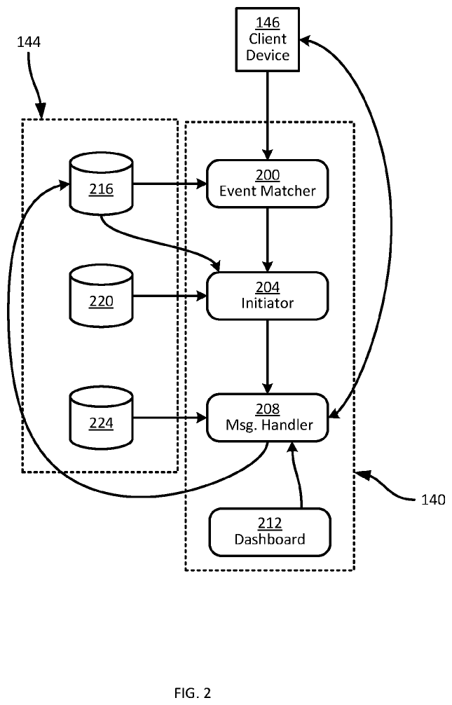

Turning to FIG. 2, certain components of the application 140 and repository 144 are discussed in greater detail. In other examples, the application 140 and repository 144 can be deployed as different sets of components than those illustrated, so long as such components perform the functions described herein.

The application 140 includes, in the illustrated example, an event matcher 200 (which may also be referred to as a timing tuner), an initiator 204 (which may also be referred to as an event detector, trigger algorithm, and/or trigger input), a message handler 208, and a dashboard 212. The event matcher 200 is configured to detect that a given user is observing a particular live event, via receipt of recorded multimedia data from the client device 146. By matching the recorded multimedia data to the broadcast data 116 (e.g. retrieved from a first repository 216 used to contain the broadcast data 116, the metadata 142, and other received data), the event matcher 200 determines that the user is observing the live event 104 corresponding to the broadcast data 116, and also determines the time delay between the live event 104 and the broadcast data 116.

The initiator 204 receives an event identifier (in embodiments in which the server 130 processes broadcast data for a plurality of events) and a user identifier corresponding to the client device 146, e.g. from the event matcher 200. The initiator 204 can also receive the above-mentioned time delay from the event matcher 200. The initiator 204 is configured to employ the above data, as well as the metadata 142 retrieved from the first repository 216, to select a moment from the live event 104 for which to generate an interactive communication. The initiator 204 is further configured to select an interactive communication definition to generate for the selected moment. The selection of a moment from the metadata 142, as well as the selection of an interactive communication definition, can be made based on a set of selection criteria stored in a second repository 220. The repository 220, in other words, defines criteria that the initiator 204 can assess for each moment in the stream of metadata 142 in order to determine whether to generate an interactive communication for that moment. The repository 220 can also include criteria used to select a particular interactive communication definition once a moment has been selected, e.g. when more than one interactive communication definition is available for the type corresponding to the selected moment.

The message handler 208 is configured to receive instructions from the initiator 204 to generate and send an interactive communication according to a particular definition, addressed to a particular user (corresponding to the client device 146). The message handler 208 is then configured to retrieve the relevant definition from a third repository 224 of interactive communication definitions, and generate the interactive communication. Generation of the interactive communication can also include retrieval of data from the first repository 216, e.g. metadata 142, profile data corresponding to the client device 146, or the like.

The message handler 208 is also configured to receive any responses from the client device 146 arising from the interactive communication. In some examples, the definition employed to initiate the interactive communication defines a multi-stage exchange of messages. In those examples, the message handler 208 can generate and send further messages according to the definition upon receiving responses. The responses can also be stored in the repository 216, e.g. in association with a user profile corresponding to the client device 146.

The dashboard 212 is configured to receive input from an administrator or other operator of the server 130, e.g. to reconfigure the server 130 (e.g. by updating the contents of the repositories 220 or 224), and/or to manually trigger the transmission of an interactive communication. That is, in some examples the dashboard 212 enables the receipt of input data via the I/O assembly 138 instructing the message handler 208 to generate an interactive communication, irrespective of the results of the criteria-based assessment of the initiator 204.

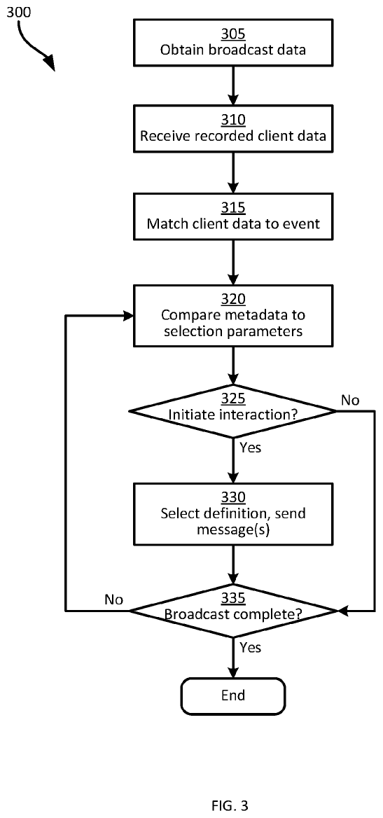

Turning now to FIG. 3, a flowchart of a method 300 for initiating real-time event-associated interactive communications is illustrated. The method 300 will be described below in conjunction with its performance by the server 130, via the execution of the application 140 by the processor 132.

At block 305, the server 130 is configured to obtain broadcast data, e.g. by receiving the broadcast data 116. The server 130 can receive the broadcast data 116 substantially in real time, e.g. without the time delay applied to the broadcast data 116 before rendering at the broadcast device 120. The server 130 also receives, at block 305, the metadata 142 mentioned above. The metadata 142 includes a stream of moments, e.g. detected by a third-party service. Each moment can be defined by a set of values, such as a moment type (e.g. a penalty kick call), and a timestamp indicating the time at which the moment occurred during the live event 104. Depending on the type of the moment, various other data may also be included in the set of values. For example, in the case of a penalty kick call as mentioned above, the set of values can include an identifier of the team against which the call was made, and an identifier of the team in whose favor the call was made. As will be apparent, the receipt of broadcast data 116 and metadata 142 continues throughout the remainder of the method 300.

At block 310, the server 130 is configured to receive recorded multimedia data from the client device 146. For example, the processor 148 can control the capture assembly 160 to record audio and/or video data for a period of time (e.g. five seconds, although shorter or longer periods are also contemplated). Such control can occur in response to receipt of a command from the user at the I/O assembly 154, e.g. to trigger an event identification process for the live event 104 being rendered at the broadcast device 120. The user, in other words, need not provide input data identifying the live event 104. Instead, the user is required only to initiate an automated identification process, in which the recorded data is collected and transmitted to the server 130.

In other examples, at block 310 the data received from the client device 146 can include an explicit indication of the broadcast being observed at the client device 146. For example, the client device 146 can receive input data from a user thereof, for transmission to the server 130, that includes an identifier of a television network or the like, and/or an identifier of a telecommunications service provider, and/or an identifier of the live event itself. Such identifiers can be entered at the client device 146 in text fields or the like, or the server 130 can provide a list of available events to the client device 146 in response to an initial query by the client device 146, and the above identifiers can be selected from such a list.

At block 315, the server 130 (e.g. via the event matcher 200) is configured to match the recorded data received from the client device 146 to a broadcast. In particular, the server 130 is configured to determine, from the at least one broadcast stream (e.g. the broadcast data 116) received at block 305, which broadcast stream contains data matching the recorded data. Such a match indicates that that broadcast is being rendered in physical proximity to the client device 146, and therefore that the user is observing the corresponding live event, as represented by the broadcast data. In some examples, the broadcast data 116 can include tags or other indicators that are inaudible to human users, but are detectable by the server 130 and distinguish broadcasts from each other. The event matcher 200 can therefore be configured to identify such inaudible sequences in the recorded data, and identify which broadcast stream contains the same inaudible sequences.

The server 130 is also configured, at block 315, to determine the time delay, if any, applied to the broadcast data 116 as transmitted to the broadcast device 120. For example, the server 130 can identify an inaudible sequence as mentioned above in the recorded data, and compare the time at which the recorded sequence occurs to the time at which a matching sequence occurs in the broadcast data 116. The difference between the two times is the time delay. In other examples, e.g. in which the client device 146 provides explicit identifiers of the event and/or broadcast to the server 130, the server 130 can determine the time delay by looking up the delay in a preconfigured table. In further examples, the server 130 can detect the delay between real-time and the broadcast data 116, e.g. based on the metadata 142. Matching the client device 146 to a particular broadcast (and therefore a particular detected delay) can then be achieved by way of the above-mentioned identifiers.

At block 320, the server 130 is configured to compare the metadata 142 to a set of selection criteria, stored in the repository 220 mentioned above. In general, the metadata 142 defines a sequence of moments occurring in the live event 104, and thus block 320 is performed for each event in the sequence. As mentioned above, each moment is defined by a timestamp, a moment type, and optionally a set of additional values (e.g. dependent on the moment type).

Broadly, the selection criteria in the repository 220 are configured to result in the selection of certain moments for generation of interactive communications, while ignoring or discarding other moments. As will be apparent, the total number of moments represented in the metadata 142 over the course of the live event 104 can be substantial (e.g. in the tens or hundreds). Generating interactive communications for every moment may therefore result in an undesirably high number of interactive communications being sent to the client device 146. Further, certain moments (e.g. out of bounds moments in a soccer game) may be expected to be of less interest to users than others (e.g. penalty kicks). The selection process at block 320 therefore seeks to identify a subset of the moments defined in the metadata 142 for which to generate interactive communications. At block 325, the server 130 is configured to determine whether to initiate an interactive communication for the moment under consideration.

A variety of selection criteria are contemplated. For example, the selection criteria can include priority levels assigned to certain moment types. For example, certain moment types can be defined in the repository 220 as low-priority, and therefore ignored at block 325 (i.e. a negative determination at block 325). Other moment types can be defined in the repository 220 is high-priority, and therefore result in an affirmative determination at block 325. In some cases, high-priority moments can override other selection criteria, and thus always result in an affirmative determination at block 325. Still other moments can be defined as having an intermediate priority. For those moments, the determination at block 325 can depend on additional selection criteria, such as those discussed below.

The selection criteria can also include one or more frequency criteria. For example, the frequency criteria can define a minimum time period between interactive communications. Therefore, the determination at block 325 for a given moment can be negative if an affirmative determination was made at a previous performance of block 325 within the minimum time period, and affirmative otherwise.

The selection criteria can also include scheduling criteria, e.g. specifying time windows during which interactive communications are to be generated. For example, the scheduling criteria can specify that interactive communications are to be generated at the beginning and end of the event 104, as well as half-way through the event 104. Thus, the determination can be affirmative at block 325 if the relevant moment occurs within five minutes (or any other configurable window) of the scheduled point during the event.

Further examples of selection criteria include criteria based on user profile data. For example, the repository 216 can contain preferences corresponding to the client device 146, e.g. indicating preferences for certain moment types, frequency of interactive communications, or the like.

Following a negative determination at block 325, the generation of interactive communications at block 330 is bypassed, and the server 130 proceeds directly to block 335, at which the server 130 determines whether the broadcast of the live event 104 is complete. When the determination at block 335 is affirmative, the server performance of the method 300 ends. Otherwise, the server 130 returns to block 320 to process the next moment defined in the metadata 142.

When the determination at block 325 is affirmative, the server 130 proceeds to block 330. At block 330, the server 130 selects an interactive communication definition from the repository 224, and generates and sends one or more messages to the client device 146 according to the selected definition.

When the repository 224 contains a single definition corresponding to the moment type for which the affirmative determination was made at block 325, at block 330 the server 130 (e.g. the initiator 204) selects that definition. When the repository contains more than one definition for the relevant moment type, the initiator 204 can be configured to apply further selection criteria at block 330 to select one of the available definitions. For example, the definition may simply be selected randomly between those matching the relevant moment type. In other examples, the initiator 204 can determine which definition was most recently used to send a communication to the client device 146, and omit that definition from the selection. In further examples, the initiator 204 can compare the available definitions to a user profile corresponding to the client device 146, e.g. to select a definition including content that matches one or more user preferences. For example, in the context of a sporting event involving opposing teams, a user profile corresponding to the client device 146 may indicate a preferred team of the user. The repository 224 can contain, for at least some definitions, alternate versions of a definition with language biased towards respective first and second teams. For a definition defining a message about a given team, the initiator 204 can therefore select the version with the appropriate bias, based on the user's preferred team.

Having selected a definition, the initiator 204 is configured to generate an interactive communication according to the definition, and transmit the communication to the client device 146 via the network 112. In particular, each interactive communication definition defines at least one message, and can define a sequence of messages (e.g. including branching sequences of messages, dependent on response data to earlier messages). The message can be defined by either or both of static content and dynamic content. The dynamic content can be dependent on the metadata 142, the identity of the user associated with the client device 146, or the like, while the static content does not have such dependencies.

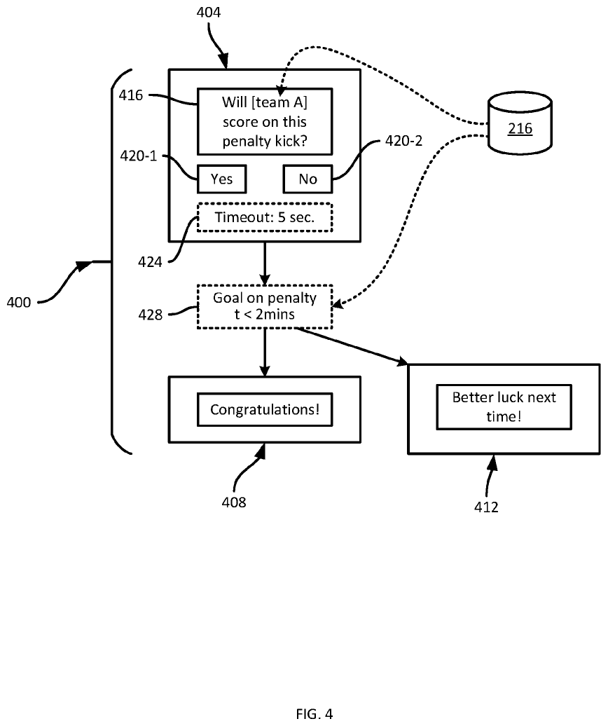

An example interactive communication definition 400 is shown in FIG. 4. The definition 400 includes three messages 404, 408, and 412, arranged in a sequence beginning with the message 404. The message 404 includes a string 416 asking the user to predict the outcome of a penalty kick. The string 416 contains static text, as well as a dynamic field into which the name of the team taking the penalty kick is inserted, e.g. from the metadata stored in the repository 216.

The message 404 also includes selectable response elements 420-1 and 420-2. The response elements 420 are selectable at the client device 146 to return a response to the question defined by the string 416 to the server 130. In addition, the message 404 includes a timeout condition 424, e.g. setting a period of five seconds, after which the selectable elements 420 will be deactivated. The timeout condition 424 can be displayed at the client device 146, but need not be.

The messages 408 and 412, as will now be apparent, are configured for transmission after receipt of a response from the user, and after the result of the penalty kick has been revealed (typically, the result will not yet be known when the message 404 is sent, since the live event 104 is being broadcast in real-time). The initiator 204 is configured to select one of the messages 408 and 412 depending on whether the user answered correctly or not. The initiator 204 determines whether the user answered correctly via a condition 428 specified in the definition 400. The condition 428 specifies, in this example, that the answer to the predictive question posed in the string 416 is determined by whether a “goal on penalty kick” moment is detected in the metadata 142 within the two minute period following transmission of the message 404. Depending on the answer determined via the condition 428 and on the selected prediction from the client device 146, either the message 408 or the message 412 will be selected and transmitted to the client device 146.

Various other actions can also be specified in the definition 400, such as updates to a user profile (e.g. to grant rewards points or the like to the user in the event of a correct answer). In some examples, updates to user profiles can include conferring ownership of a digital asset, such as a non-fungible token (NFT), in response to a correct prediction. In such examples, the definition 400 can also specify a transaction to apply to a distributed ledger external to the server 130, to document the ownership of the NFT.

As will now be apparent, the definitions in the repository 224 can construct various other forms of interactive communications, including trivia questions and the like.

The delivery mechanism employed to transmit the messages mentioned above can vary widely. For example, the message handler 208 can implement a chatbot application, a web application, an email server, an instant messaging server, or the like, for exchanging messages with the client device 146. The message handler 208 is further configured to pass any response data received from the client device 146 to the repository 216, e.g. for subsequent processing to update user profiles, generate reporting data visible via the dashboard 212, and the like.

As will be apparent, the above systems and methods can also be applied to other forms of broadcasts, such as television shows, movies, newscasts, and the like.

The scope of the claims should not be limited by the embodiments set forth in the above examples, but should be given the broadest interpretation consistent with the description as a whole.

1. A method in an integration server, the method comprising:
obtaining broadcast multimedia data representing a live event;
receiving, from a client device, recorded multimedia data collected via a sensor of the client device;
based on a comparison of the broadcast multimedia data and the recorded multimedia data, determining that the recorded multimedia data represents the broadcast multimedia data being rendered in physical proximity to the client device;
in response to the determination, selecting one of a plurality of interaction definitions corresponding to the live event; and
controlling a message generator to transmit a message to the client device according to the interaction definition.

2. The method of claim 1, wherein the live event is selected from a group including: a sporting event, an e-sports event, an awards show, a movie, and a television show.

3. The method of claim 1, further comprising:
obtaining a plurality of sets of broadcast data representing distinct live events; and
comparing the recorded multimedia data to each of the sets of broadcast data to match the client device with one of the live events.

4. The method of claim 3, wherein the interaction definitions include distinct subsets of interaction definitions corresponding to respective event types of the distinct live events; and
wherein selecting the one of the interaction definitions includes selecting an interaction definition corresponding to the event type of the live event.

5. The method of claim 1, wherein selecting one of the plurality of interaction definitions includes:
obtaining metadata corresponding to the broadcast multimedia data, the metadata defining a moment occurring within the live event;
storing, in connection with each interaction definition, a respective one of a set of moment types; and
selecting the one interaction definition having a moment type matching a type of the moment defined in the metadata.

6. The method of claim 5, wherein selecting one of the plurality of interaction definitions further includes:
storing selection parameters defining an interaction frequency;
determining whether a time period between interactions has elapsed, based on the interaction frequency; and
in response to determining that the time period has elapsed, selecting the one interaction definition

7. The method of claim 1, wherein the message generator includes one of a chatbot, an email server, and an instant message server.

8. An integration server, comprising:
a communications interface;
a processor configured to:
obtain broadcast multimedia data representing a live event;
receive, from a client device, recorded multimedia data collected via a sensor of the client device;
based on a comparison of the broadcast multimedia data and the recorded multimedia data, determine that the recorded multimedia data represents the broadcast multimedia data being rendered in physical proximity to the client device;
in response to the determination, select one of a plurality of interaction definitions corresponding to the live event; and
control a message generator to transmit a message to the client device according to the interaction definition.

9. The integration server of claim 8, wherein the live event is selected from a group including: a sporting event, an e-sports event, an awards show, a movie, and a television show.

10. The integration server of claim 8, wherein the processor is further configured to:
obtain a plurality of sets of broadcast data representing distinct live events; and
compare the recorded multimedia data to each of the sets of broadcast data to match the client device with one of the live events.

11. The integration server of claim 10, wherein the interaction definitions include distinct subsets of interaction definitions corresponding to respective event types of the distinct live events; and
wherein the processor is configured, to select the one of the interaction definitions, to select an interaction definition corresponding to the event type of the live event.

12. The integration server of claim 8, wherein the processor is configured, to select one of the plurality of interaction definitions, to:
obtain metadata corresponding to the broadcast multimedia data, the metadata defining a moment occurring within the live event;
store, in connection with each interaction definition, a respective one of a set of moment types; and
select the one interaction definition having a moment type matching a type of the moment defined in the metadata.

13. The integration server of claim 12, wherein the processor is configured, to select one of the plurality of interaction definitions, to:
store selection parameters defining an interaction frequency;
determine whether a time period between interactions has elapsed, based on the interaction frequency; and
in response to determining that the time period has elapsed, select the one interaction definition

14. The integration server of claim 8, wherein the message generator includes one of a chatbot, an email server, and an instant message server.

15. A non-transitory computer-readable medium storing instructions executable by a processor of an integration server to:
obtain broadcast multimedia data representing a live event;
receive, from a client device, recorded multimedia data collected via a sensor of the client device;
based on a comparison of the broadcast multimedia data and the recorded multimedia data, determine that the recorded multimedia data represents the broadcast multimedia data being rendered in physical proximity to the client device;
in response to the determination, select one of a plurality of interaction definitions corresponding to the live event; and
control a message generator to transmit a message to the client device according to the interaction definition.
